(19) United States
(12) Patent Application Publication
(10) Pub. No.: US 2009/0040455 A1
(43) Pub. Date: Feb. 12, 2009

(54) SYSTEM AND METHOD FOR ENHANCING EYEGLASS POSITIONING

(76) Inventor: TOMOKO TAHARA, Tokyo (JP)

Correspondence Address: LACKENBACH SIEGEL, LLP, LACKENBACH SIEGEL BUILDING, 1 CHASE ROAD, SCARSDALE, NY, 10583, US

(21) Appl. No.: 12/123,284

(22) Filed: May 19, 2008

Related U.S. Application Data
(60) Provisional application No. 60/954,976, filed on Aug. 9, 2007.

(51) Int. Cl. G02C 11/02; G02C 11/00

(52) U.S. Cl. 351/51; 351/158

(57) ABSTRACT

A system and method for enhancing eyeglass positioning and thereby improving user comfort, wherein additional masses are connectively suspended from the ends of glasses arms allowing both added weights to retain the glasses, and also in an alternative embodiment via the suspending means providing additional friction contact on the surfaces of the ear. A consequence of the present invention is that nose-contact pressure, temple contact pressure, and other facial contact pressure is minimized via an improved weight balance and motion through all ranges of user motion.

### CROSS REFERENCE TO RELATED APPLICATIONS

This application relates to and claims priority from U.S. Prov. App. 60/954,976 filed Aug. 9, 2007, the entire contents of which are herein incorporated fully by reference.

### BACKGROUND OF THE INVENTION

1. Field of the Invention

The present invention relates to a system and method for enhancing comfort for eyeglass users. More specifically, the present invention relates to a system and method for facilitating and maintaining proper positioning of the eyeglass on a user head as well as relieving pressure on a wearer's face, the temple, nose and ears during eyeglass use. The present invention also relates to eyeglasses having flexible side arms, there being counterweight members mountable suspended at rear tip ends of the side arms. The counterweight members function to secure capture of the eyeglass to a user head at times when the user head is tilted downwardly, and gravity imposes an effect tending to cause the eyeglass drop off the user head. The counterweights, when the user head is level, tend to rotate the front of the eyeglass upwardly to produce pressure easing on the face skin, nose, ears and temple sides.

2. Description of the Related Art

The related art involves those individuals having vision problems such as near sightedness, far sightedness, and astigmatism, these needs requiring correction by use of prescription eyeglasses. Similarly, this invention relates to those who wear heavy or burdensome safety glasses or other glasses with or without a prescription.

As a person ages the need for prescription eyewear increases through the effects of basic physiological degradation. Invariably, almost any person older than about 50-60 years needs reading eyeglasses or other corrective procedures. As the prescription “amount” or “degree” increases, the lenses employed become thicker and heavier due to the increased requirement for a larger angle of refraction through the lens.

Conventionally, it is recognized that for the vast majority of users there is no other viable option, other than eyeglasses, to correct their vision.

While state of the art technology has increasingly lightened the weight of eyeglasses by substituting higher density lens material, the basic structure of eyeglasses has not changed significantly over time. Specifically, conventional eyeglasses comprise the lenses (made of glass or plastic) being carried in a frame, the frame having side arms to attach the frame to the user and nose pads. The side arms and the nose pads keep the eyeglass in proper position on the face but in so doing, can exert a discomforting pressure on the face, ears and the nose. An eyeglass wearer also may experience pain, and could receive physical skin marking on either the nose or between the eyebrows, such being cosmetically unacceptable.

To prevent slippage, a few solutions have been proposed all failing to date, including the addition of non-skid surface on the side arms of the frames. This increases friction on the user's face and leads to discomfort. For example, in Bidgood (U.S. Pat. No. 3,768,892) and Cloessner (U.S. Pat. No. 4,161,628), the entire contents of each of which are incorporated herein, such attempts at improvements are unfortunately unsuccessful. The patent '892 embodies a weight at the terminal length or hook member of the side arm, the terminal length being bent down at a shallow angle to the side arm main length. With this arrangement, the terminal length would be effective to provide eyeglass retention on the ear when the user slightly tilts the head downwardly but at no other time. Another embodiment of the '892 patent embodies a weight within a channel member attachable to the hook member. But this does not rectify the problem of the shallowness of the hook member and possible slide off of the eyeglass on the ear when the user tilts the head. The '628 patent also embodies a weight in the tip end of the side arm hook member as a fixed part of the side arm. If the weight proves to be insufficient for the purpose of obviating eyeglass slide of when the user tilts the head, the side arm must be replaced and is completely inadaptable.

It is clear that no appreciation exists in the prior art of a solution which enhances user comfort while simultaneously adapting to different user head positions and physical activities.

### OBJECTS AND SUMMARY OF THE INVENTION

An object of the present invention is to provide an eyeglass at least one of the needs noted above. More specifically, the invention provides an eyeglass which produces reduced or minimized downward gravitational pressure on a wearer's face portions including nose, ear, and temple regions, during any user activity including reading, writing, and working with the hands.

An additional object is to provide an eyeglass which embodies a counterweight that functions to insure prevention of eyeglass slide off when a user tilts the head downwardly.

Another object is to allow changing the counterweight without altering the structure of the side arms.

According to the present invention, an eyeglass assembly or system is provided having a bridge or frame which carries lenses, there being side arms extending past the lower temple area and onto supporting contact atop the user's ears. A weight is removably connectable to a rear tip end of the respective arms, e.g., with a preferably flexible suspender member to support the weight at a distance below the ear. The weight produces a levering force in the side arms tending to pivot the frame and lenses upwardly thereby reducing or diminishing eyeglass induced pressure on the wearer's face area. The weight can be embodied as a, e.g., single piece member of a selected shape or it can be plural members, the weight members being of varied shapes. The shapes can be, for example, spherical, cylindrical, truncated pyramid, torus configured, etc. An advantage of selecting shapes as aforesaid is that the weight members can serve as earring pieces.

When a user tilts the head downwardly, the counterweight serves to counterbalance the action of gravity thereby to hold the eyeglass from falling off the wearer's faces. Additionally, the suspender and flexible weights nest closely behind the wearer ear and additionally act as a slide-anchors thereby holding the eyeglass properly and securely held to the user's face. Where the side arms, suspender pieces and weights are in contact with skin on the user head, these contacts add to the holding force positioning the eyeglass.

The invention also provides a method for reducing eyeglass weight imposed pressure at face and head areas that come into contact with the eyeglass structure.

The above, and other objects, features and advantages of the present invention will become apparent from the following description read in conduction with the accompanying drawings, in which like reference numerals designate the same elements.

### BRIEF DESCRIPTION OF THE DRAWINGS

FIG. 1 is a perspective view of an eyeglass constructed in accordance with the invention, the eyeglass embodying a flexible counterweight removably affixed at a rear tip end of the eyeglass side arms.

FIG. 2A is a left side perspective view of the positioning of the eyeglass on the user head when the head is level upright.

FIG. 2B is a perspective view like FIG. 2A except the user head is tilted downwardly, a condition wherein the counterweight and suspender piece closely conform in contact with the rear side of the user ear so that the counterweight and suspender define an anchor holding the eyeglass at the face in proper positioning thereof.

FIG. 3 is a fragmentary side view depiction of an embodiment of one manner of affixing the suspender piece to the side arm and noting a break after the suspender piece where additional weights, connection points, or additional members may be attached.

### DETAILED DESCRIPTION OF THE PREFERRED EMBODIMENTS

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, and below may be used with respect to the drawings. These and similar directional terms should not be construed to limit the scope of the invention in any manner. The words “connect”,“couple”, and similar terms with their inflectional morphemes do not necessarily denote direct and immediate connections, but also include connections through mediate elements or devices.

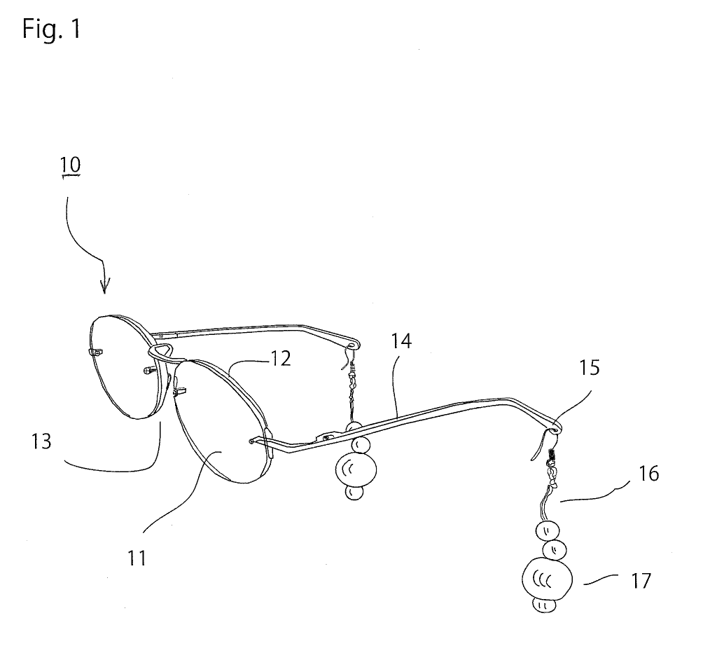

Referring to the FIG. 1 embodiment, the eyeglass 10 is of customary construction to the end that it has a pair of lenses 11 mounted in a frame 12, the frame being connected at the two ends thereof with front first ends of side arms 14. Opposite rear ends 15 of the side arms 14 serve to mount counterweights 17. Nose engageable tabs 13 function to support the frame 12 on the user's face.

The counterweights 17 can be comprised of a single member or each may be made up of plural members, some of which are of different size (and hence, different weight) than others of said members. By using weight members of varying sizes it is easy to set necessary counterweight values to counterbalance the weights of eyeglasses of various sizes, construction and materials, and this to relieve any undesirable or discomforting pressure exerted on a user's face by the eyeglass structure.

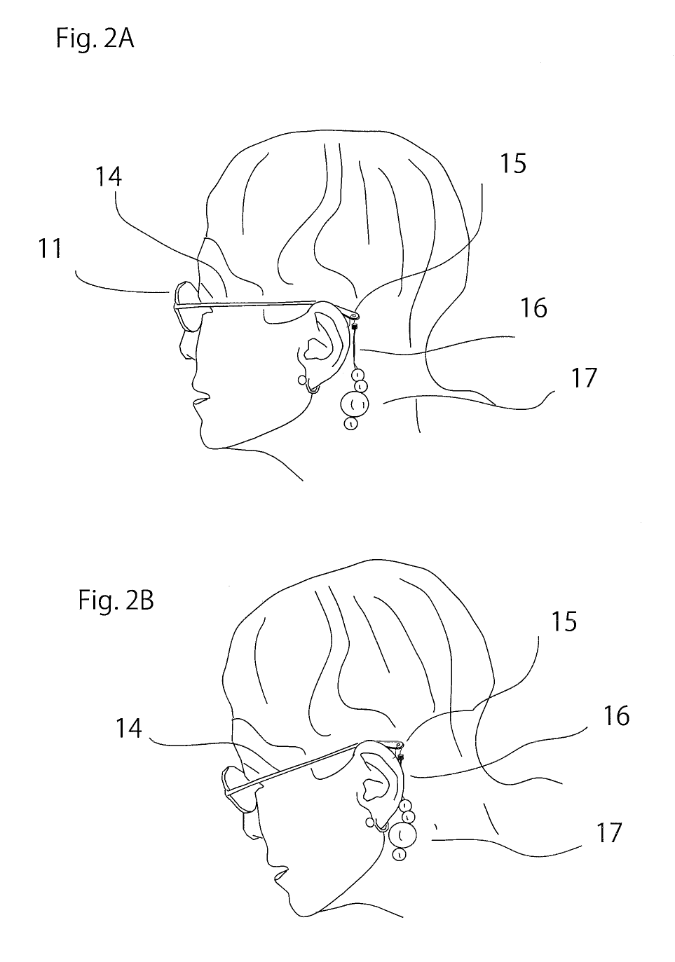

While the counterweights 17 are depicted as comprising a plurality of spherical members or beads, nothing shall so limit the design of the counterweights 17, and they may be shaped in a plurality of regular or irregular shapes, may be flexible or individually rigid/solid, and may even be magnetic in an effort to promote the conventionally recognized medical benefits of magnetic use. The beads will total the weight needed to counteract the weight of the eyeglass at the front major portion structure thereof. The counterweight 17 can be sized and of materials to provide counterweight total weight in a range of about 0.10-5.00 oz, and more preferably 0.10-2.00 oz, that total being, for example, for a one counterweight or for the sum weight of all beads in a plural bead counterweight (one or the sum of the weights of a plurality). With the eyeglass positioned on the wearer in a normal FIG. 2A head level orientation, the weight of this front major portion multiplied by the length of the side arm 14 extending forwardly from the fulcrum point, i.e., where the side arm sits on the ear to the front end of the side arm, imposes a pressure on the wearer's face and nose which aside from being discomforting, can be in some instances, injurious to the face.

The counterweights 17 which are located at the opposite side of the fulcrum point and weighted to such purpose, produce a force tending to lift the eyeglass major front portion upwardly, the result being that the pressure imposed by the major front portion on the wearer's face is relieved or lessened to a degree wherein discomfort to the face is mitigated to acceptable level.

The counterweights 17 are attached as at 15 by suspension thereof with suspender pieces 16 from the rear opposite ends of the side arms 14. The suspender pieces 16 desirably are flexibly structured so that weights 17 can swing freely from the swing joint means 15.

The counterweights 17 can be made of anyone of a number of materials including a metal such as lead, a stone, a synthetic material etc. The suspender pieces 16 can be made of materials inclusive of a leather, a soft material or as a soft alloy decorative chain having flexibility to provide gentle smooth engagement of such member with the user's ears. The counterweights also may be constructed such as to present a decorative effect. Further, the suspender piece and counterweight associated therewith can be fashioned as an earring item

When a user tilts the head downwardly when reading, writing, or working with the hands as depicted in FIG. 2B, the counterweights and the suspender pieces exert force on the eyeglass tending to overcome the effect of gravity which if not thwarted would cause the eyeglass to slip down from proper and needed positioning on the face. This is not only the result of counterweight effect but also the flexible nesting of the suspender pieces 16 and at least a part of the counterweight 17 against the back of the ear in the fashion of an anchor component.

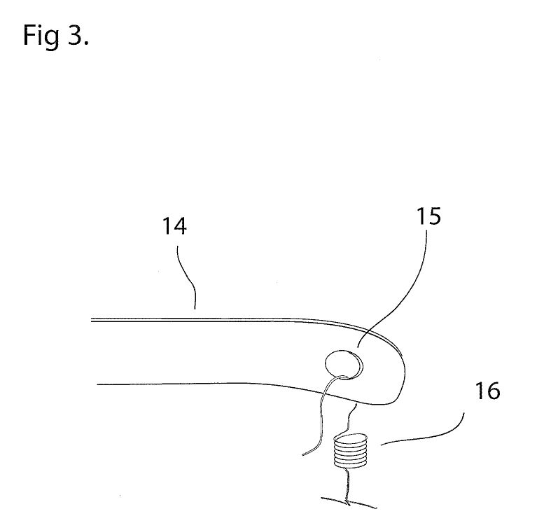

FIG. 3 shows one embodiment of the manner of removably affixing the suspender piece 16 to the rear end of an eyeglass side arm 14, although nothing herein shall so limit the mechanism for removing or replacably attaching the weights or the suspender piece 16. As shown in such embodiment, the suspender piece upper end is fashioned as a spring coil, a loop extension at the coil top passing through an opening 15 in the side arm 14 rear end. A bottom line runs from the coil extending down to be connected to a counterweight of a suitable design (the drawing shows the break-line between the coil extending downwardly and a potential counterweight attachment). The spring coil arrangement adds to the flexible and bendable-engagement character of the counterweight/suspender piece and also contributes to the appearance of these components when fashioned as an earring.

In accordance with a method for reducing pressure imposed on an eyeglass wearer's face by lens and lens frame structure, a first end of a suspender piece 16 is attached to an eyeglass side arm tip end which extends rearwardly a distance behind the ear. A weight member 17 is then affixed to a second opposite end of the suspender piece. The weight and suspender piece serve to impose levering force at the side arm tip end which tends to pivot the lenses and frame structure upwardly on the wearer's face to thereby diminish eyeglass weight induced pressure at the wearer's face.

In the claims, means- or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

What is claimed is:

1. An eyeglass system, comprising:
a lens frame;
a pair of lenses carried in said frame;
a pair of side arms attached at first ends thereof to respective ones of opposite ends of said lens frame, said side arms extending rearwardly a distance to pass onto and past a wearer's ears;
a pair of weight members; and
elongated suspender pieces connected at first ends thereof to opposite second ends of each of said side arms, the respective weight members being connected to respective second ends of said suspender pieces, whereby the weight members tending to pivot the lens frame and lenses upwardly on the wearer's face thereby diminishing effect of eyeglass weight induced pressure on the wearer's face area.

2. An eyeglass system, in accordance with claim 1, wherein:
the weight members each have a mass weight which is one in a range of between about 0.2 oz. to about 5.0 oz.

3. An eyeglass system, in accordance with claim 1, wherein:
the first ends of the suspender pieces are connected to the second ends of said side arms with a swing joint enabling free movement of the suspender piece and the weight member connected therewith relative to said side arms.

4. An eyeglass system, in accordance with claim 1, wherein:
said suspender pieces are flexibly structured members.

5. An eyeglass system, in accordance with claim 1, wherein:
the suspender pieces are one of a string material, a plastic material, an elastomeric material, a leather material, a soft cloth material, and a soft alloy chain member.

6. An eyeglass system in accordance with claim 1, wherein:
each suspender piece and the weight member connected therewith are fashioned as an earring item.

7. A method for reducing pressure imposed on a eyeglass wearer's face by lens and lens frame structure of the eyeglass during eyeglass use, the eyeglass having side arms supporting the frame and lens structure on the face with the side arms disposed in contact with the wearer's ears with a side arm tip end extending a distance rearwardly of the ear, said method comprising the steps of:
attaching a first end of a suspender piece to side arm tip ends and in such manner that the suspender pieces can move freely on the side arms;
affixing a weight member to a second opposite end of each suspender piece so that weights impose a levering force at said side arm tip ends tending to pivot the lenses and lens frame structure upwardly on the wearer's face thereby to diminish eyeglass weight induced pressure at the wearer's face.

8. The method of claim 7, in which:
the weight members each have a mass weight which is one in a range of between about 0.2 oz. and about 5.0 oz.

9. The method of claim 7, in which:
the suspender pieces are flexibly structured members.

10. The method of claim 7, in which:
each suspender piece and the weight affixed thereto is fashioned as an earring item.

11. The method of claim 7, wherein:
distal ends of each respective suspender pieces are joined by a joining member; and
the joining member is flexible.

12. An eyeglass assembly, comprising:
an eyeglass member, further comprising:
a lens frame;
a pair of lenses carried in said frame;
a pair of side arms attached at first ends thereof to respective ones of opposite ends of said lens frame, said side arms extending rearwardly a distance to pass onto and past a wearer's ears;
a balancing and adjusting system, comprising:
a pair of weight members;
respective elongated suspender pieces connected at first ends thereof to opposite second ends of each of said side arms, the respective weight members being connected to respective second ends of said suspender pieces, the weight members tending to pivot the lens frame and lenses upwardly on the wearer's face thereby diminishing effect of eyeglass weight induced pressure on the wearer's face area.

13. An eyeglass assembly, in accordance with claim 12, wherein:
the weight members each have a mass weight which is one in a range of between about 0.2 oz. to about 5.0 oz.

14. An eyeglass assembly, in accordance with claim 12, wherein:
the first ends of the suspender pieces are connected to the second ends of said side arms with a swing joint enabling free movement of the suspender piece and the weight member connected therewith relative to said side arms.

15. An eyeglass assembly, in accordance with claim 12, wherein:
said suspender pieces are flexibly structured members.

16. An eyeglass assembly, in accordance with claim 12, wherein:
the suspender pieces are one of a string material, a plastic material, an elastomeric material, a leather material, a soft cloth material, and a soft alloy chain member.

17. An eyeglass assembly, in accordance with claim 12, wherein:
each suspender piece and the weight member connected therewith are fashioned as an earring item.

18. An eyeglass assembly, in accordance with claim 12, wherein:
distal ends of each respective suspender pieces are joined by a joining member; and
the joining member is flexible.
